(19) United States
(12) Patent Application Publication
(10) Pub. No.: US 2014/0368176 A1
(43) Pub. Date: Dec. 18, 2014

(54) GENERATING A ROOT OF AN OPEN-LOOP FREQENCY RESPONSE THAT TRACKS AN OPPOSITE ROOT OF THE FREQUENCY RESPONSE

(71) Applicant: STMicroelectronics International N.V., Amsterdam (NL)

(72) Inventors: Pralay MANDAL, Kolkata (IN); Sajal Kumar MANDAL, Howrah (IN)

(21) Appl. No.: 13/915,828

(22) Filed: Jun. 12, 2013

(51) Int. Cl. G05F 1/445

(52) U.S. Cl. CPC G05F 1/445
USPC 323/280

(57) ABSTRACT

In an embodiment, an electronic includes a feedback-coupled circuit stage and a compensation circuit stage. The feedback-coupled stage is configured to drive a load, and the compensation stage is coupled to the feedback-coupled stage such that a combination of the compensation and feedback-coupled stages has a frequency response including a first root and an opposite second root that depend on the load. For example, an embodiment of such an electronic circuit may be a low-dropout (LDO) voltage regulator that lacks a large output capacitance for forming a dominant pole to stabilize the regulator. The regulator includes a feedback-coupled stage that generates and regulates an output voltage, and includes a compensation stage that is designed such that the frequency response of the regulator includes a zero that tracks a non-dominant output pole of the regulator so that the output pole does not adversely affect the stability of the regulator.

### SUMMARY

In an embodiment, an electronic circuit includes a feedback-coupled stage and a compensation stage. The feedback-coupled stage is configured to drive a load, and the compensation stage is coupled to the feedback-coupled stage such that the circuit, which is a combination of the compensation and feedback-coupled stages, has a transfer function, i.e., a frequency response, including a first root and an opposite second root that depend on the load.

An embodiment of such an electronic circuit may be a low-drop-out (LDO) voltage regulator that lacks a large output capacitance for forming a dominant pole to stabilize the regulator; for example, such an LDO voltage regulator may be an on-chip circuit that generates a voltage for one of multiple separate voltage islands inside a system on a chip (SOC), where including such a large output capacitance may be impractical. The LDO regulator includes a feedback-coupled stage that generates and regulates an output voltage, and includes a compensation stage that imparts to the frequency response of the regulator a zero that tracks a non-dominant output pole of the regulator's frequency response so that the output pole does not degrade the stability of the regulator, particularly at lighter loads that draw lower load currents. Furthermore, the compensation stage may also impart to the frequency response of the regulator a dominant pole that stays within a relatively small frequency range over a relatively large range of load levels.

### BRIEF DESCRIPTION OF THE DRAWINGS

FIG. 1 is a diagram of a LDO voltage regulator.

FIG. 2 is a diagram of a system that includes circuit islands each having a respective LDO voltage regulator, according to an embodiment.

FIG. 3 is a diagram of a load, and of a circuit that includes a feedback-coupled stage configured to drive the load and a compensation stage configured to stabilize the circuit, according to an embodiment.

FIG. 4 is a schematic diagram of a load, and of a LDO voltage regulator that is an implementation of the circuit of FIG. 3 and that is configured to provide a regulated supply voltage to the load, according to an embodiment.

FIG. 5 is a circuit model of the load and of the LDO voltage regulator of FIG. 4, according to an embodiment.

FIG. 6 is a plot of the output pole and the tracking zero of the LDO voltage regulator of FIG. 4 versus frequency, according to an embodiment.

FIG. 7 is a Bode plot of the open-loop magnitude and phase of the LDO voltage regulator of FIG. 4 at two different load currents, according to an embodiment.

FIG. 8 is a diagram of a system that may incorporate the circuit of FIG. 3, for example, in the form of the LDO voltage regulator of FIG. 4, according to an embodiment.

### DETAILED DESCRIPTION

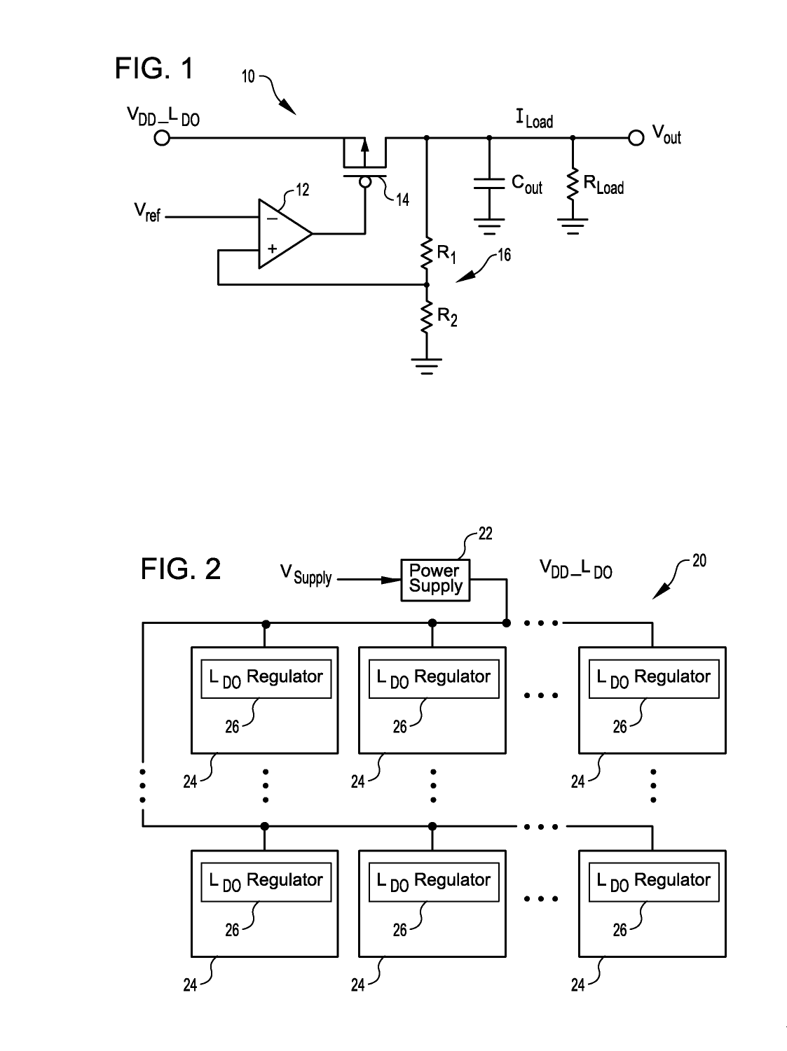

FIG. 1 is a schematic diagram of a LDO voltage regulator 10, which is configured to provide a regulated output voltage Vₒᵤₜ to a load, which is modeled as a resistor R_{Load}. Although the load may be described as being a resistive load R_{Load}, the load may also have a reactive component such as a capacitive component Cₒᵤₜ as shown in FIG. 1. Cₒᵤₜ may represent only the capacitance of the load, or it may represent the combination of the load capacitance and a separate output capacitance that is in parallel with the load.

The LDO regulator 10 includes a high-gain amplifier 12, a PMOS pass transistor 14, a voltage divider 16 including resistors R₁ and R₂, and an output capacitor Cₒᵤₜ—if the load has a capacitive component, then the capacitance of this component may be accounted for in the value of Cₒᵤₜ as described above. The amplifier 12 includes an inverting node “−” coupled to receive a stable (e.g., a band-gap) reference voltage V_{ref}, and includes a non-inverting node “+” coupled to receive a feedback voltage V_{FB} from the junction of the resistors R₁ and R₂. The PMOS transistor 14 has a source coupled to receive an input voltage V_{DD}_{_{—}}_{LDO}, a drain coupled to provide Vₒᵤₜ, and a gate coupled to the output node of the amplifier 12.

In operation, the amplifier 12 controls the conductance of the PMOS pass transistor 14 so as to regulate Vₒᵤₜ to a particular voltage (e.g., 1.3 Volts (V)) by maintaining V_{FB} equal to V_{ref}, at least within a tolerance dictated, at least in part, by the input offset error and gain of the amplifier. Because the PMOS transistor 14 can conduct a current even while its source-drain voltage is relatively low, the regulator 10 can generate Vₒᵤₜ to have a magnitude that is almost equal to the magnitude of V_{DD}_{_{—}}_{LDO}. For example, depending on the value of the effective load resistance R_{Load}, and, therefore, depending on the level of the load current I_{LOAD}, the regulator 10 may be able to generate Vₒᵤₜ=1.3 V from a value of V_{DD}_{_{—}}_{LDO} as low as 1.4 V. That is, the regulator 10 can operate properly even when the “head room” between V_{DD}_{_{—}}_{LDO} and Vₒᵤₜ is relatively low; hence, the term “low-drop-out regulator.” Consequently, the LDO regulator 10 may be best suited for applications in which the difference between V_{DD}_{_{—}}_{LDO} and Vₒᵤₜ is 1.0 V or less.

Still referring to FIG. 1, the output capacitor Cₒᵤₜ typically serves at least two functions.

A first function of Cₒᵤₜ is to act as a bypass capacitor that can filter step changes in the load current I_{Load}. For example, Cₒᵤₜ may provide an “injection” of current in response to a step, or otherwise sudden, increase in the load current I_{Load} until the regulation feedback loop, which includes of the voltage divider 16, the amplifier 12, and the PMOS transistor 14, responds to this increase by increasing the current through the PMOS transistor. For example, where the load is a microprocessor, such a step increase in I_{Load} may be caused by the microprocessor transitioning from a “sleep” mode to an “awake” mode. Similarly, Cₒᵤₜ may absorb an injection of current in response to a step, or otherwise sudden, decrease in I_{Load} until the regulation feedback loop responds to this decrease by decreasing the current through the PMOS transistor. For example, where the load is a microprocessor, such a step decrease in I_{Load} may be caused by the microprocessor transitioning from an “awake” mode to a “sleep” mode.

And a second function of Cₒᵤₜ is to form a lowest, i.e., dominant, pole of the regulator's frequency response such that the LDO regulator 10 is stable (i.e., does not oscillate or generate excessive “ringing” on the output voltage Vₒᵤₜ). That is, in general, Cₒᵤₜ, along with R_{Load}, R₁, R₂, and the output resistance and output conductance of the PMOS transistor 14, form a pole that is low enough in frequency such that the open-loop gain of the LDO regulator 10 is less than unity at frequencies at which the open-loop phase of the LDO regulator is greater than or equal to 180°, and such that the open-loop phase of the LDO regulator is less than 180° at frequencies at which the open-loop gain of the LDO regulator is greater than or equal to unity. Although the frequency of this dominant pole may shift with changes in R_{LOAD}, and, therefore, with changes in I_{LOAD}, a circuit designer typically makes C_{OUT} large enough, and, therefore, makes the dominant pole small enough, so that the LDO regulator 10 remains stable even when such load-induced shifts in the dominant pole's frequency occur.

A value of capacitance that allows Cₒᵤₜ to serve both of the above-described first and second functions, at least in some applications, is a value that lies within an approximate range of 100 nanofarads (nF)-10 microfarads (μF).

But unfortunately, as described below in conjunction with FIG. 2, having a capacitance value within this range may render Cₒᵤₜ unsuitable for at least some other applications.

FIG. 2 is a block diagram of a system on a chip (SOC) 20, according to an embodiment.

The SOC 20 includes a main power supply 22, circuit islands (also called “power islands” or “voltage islands”) 24, and LDO voltage regulators 26. The main power supply 22 may include a conventional power supply, such as a multiphase switching power supply.

In operation, the main power supply 22 receives an external supply voltage V_{supply}, and generates therefrom a regulated internal supply voltage V_{DD}_{_{—}}_{LDO}. For example, V_{supply} may equal 5.0 V, and V_{DD}_{_{—}}_{LDO} may equal 1.80 V.

Each LDO voltage regulator 26 converts V_{DD}_{_{—}}_{LDO} into a respective supply voltage for the respective circuit island 24 on which the LDO regulator is located. For example, V_{DD}_{_{—}}_{LDO} may equal 1.80 V, and one or more of the LDO voltage regulators 26 may each convert V_{DD}_{_{—}}_{LDO} into a respective island supply voltage equal to 1.30 V.

Because there are multiple LDO voltage regulators 26 on the SOC 20, it typically would be impractical or impossible to include, on the SOC, a respective output capacitor having the size (e.g., 100 nF-10 μF) of the output capacitor Cₒᵤₜ of FIG. 1 for each LDO regulator. Reasons for this include that it may be difficult to integrate on an integrated circuit capacitors having such a large capacitance, and, that even if one could integrate such capacitors, the SOC 20 may be too small to include such an integrated capacitor for each circuit island 24.

Furthermore, it may be impractical to include such output capacitors on a printed circuit board to which the SOC 20 is mounted, because the board may not have enough room to accommodate a respective output capacitor for each LDO voltage regulator 26.

Therefore, there is a need for a circuit topology that allows stabilizing a feedback-coupled circuit (or circuit stage), such as an LDO voltage regulator, over a relatively large range of load levels without a relatively large output capacitor.

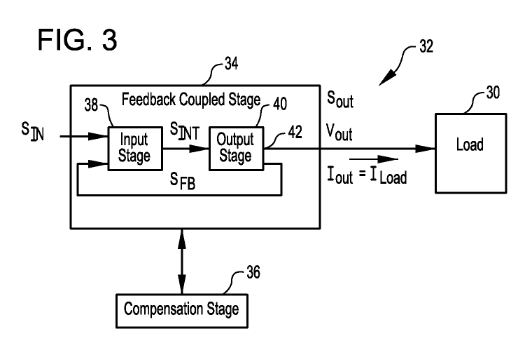

FIG. 3 is a diagram of a load 30 and a circuit 32 for providing a signal Sₒᵤₜ to the load, where the circuit stable over a relatively large range of load levels without the presence of a relatively large output capacitor.

The circuit 32 includes a feedback-coupled stage 34 and a compensation stage 36 coupled to the feedback-coupled stage; that is, the circuit 32 may be considered to be a combination of the feedback-coupled and compensation stages.

The feedback-coupled stage 34 includes an input stage 38 and an output stage 40. The input stage 38 is configured to receive an input signal S_{IN} and a feedback signal S_{FB}, and to generate an intermediate signal S_{INT} in response to S_{IN} and S_{FB}. For example, the input stage 38 may include a high-gain differential amplifier (not shown in FIG. 3) that generates S_{INT} so as to cause S_{FB} to approximately equal S_{IN}. The output stage 40 is configured to receive S_{INT} from the input stage 38, and to generate S_{FB} and an output signal S_{OUT}, which has a voltage component V_{OUT} and a current component I_{OUT}—although not shown in FIG. 3, the other signals S_{IN}, S_{INT}, and S_{FB} also have respective voltage and current components. Although I_{OUT} is shown as being equal to I_{LOAD}, in another embodiment I_{OUT} may not be equal to I_{LOAD}.

Because the feedback-coupled stage 34 includes a negative-feedback topology in which the output stage 40 feeds back the signal S_{FB} to the input stage 38, the feedback-coupled stage may be unstable if the input and output stages are not frequency compensated properly. Such instability may manifest itself, for example, in “ringing” (i.e., damped oscillations) superimposed on V_{OUT}, or in oscillation of V_{OUT}.

Because a pole or a zero of the feedback-coupled stage 34 may change as the load 30 changes, proper frequency compensation should encompass at least the entire anticipated range of the load for a particular application.

For example, as described above in conjunction with FIG. 2, when it is an output pole that may change as the load 30 changes, one way to provide such proper frequency compensation is to include a large output capacitor at an output node 42 of the output stage 40.

But as also described above, a large output capacitor may be unsuitable for some applications of the feedback-coupled stage 34, such as an application in which multiple feedback-coupled stages are integrated on a single integrated-circuit die.

Therefore, the compensation stage 36 is added to the circuit 32, and is configured to impart proper frequency compensation to the circuit throughout the entire anticipated range of the load 30 without a large output capacitor.

For purposes of explanation, assume that the circuit 32 has a transfer function, i.e., a frequency response, that includes a dominant, lower-frequency pole that, by itself, would cause the circuit to operate stably, and that includes an output pole that is at a higher frequency than the dominant pole but that is dependent on, i.e., shifts with changes in, the load 30; for example, the output pole may increase as the load current I_{LOAD} increases, and may decrease as I_{LOAD} decreases. Therefore, at one or more levels of the load 30, the output pole may be close enough to the dominant pole to cause the circuit 32 to be unstable. For example, at relatively low levels of the load current I_{LOAD}, the load-current-dependent output pole may be close enough to the dominant pole to cause the open-loop phase shift of the circuit 32 to equal or exceed 180° while the open-loop gain of the circuit is greater than or equal to unity, thus causing the circuit to oscillate. But even if the output pole does not cause the open-loop phase shift to equal or exceed 180° while the open-loop gain is greater than or equal to unity, the output pole may still be close enough to the dominant pole to cause ringing on V_{OUT}. And even if the output pole does not cause V_{OUT} to ring, it may reduce the phase margin or gain margin of the circuit 32 to a level that puts the circuit in danger of becoming unstable if one or more other parameters (e.g., temperature, process, voltage) differ from their nominal values.

But the compensation stage 36 stabilizes the circuit 32 by introducing a zero to the circuit's frequency response, where the zero tracks and fully cancels the output pole, or tracks and at least mitigates the negative affect that the output pole would otherwise have on the dominant pole as described in the preceding paragraph. It is known that if a circuit has a frequency response with a pole and a zero at the same frequency, then the pole and zero fully cancel each other such that it is as if the frequency response has neither a pole nor a zero at the frequency. But even if the pole and zero are not at exactly the same frequency, then the pole and zero may partially cancel each other if their frequencies are relatively close to each other. Therefore, the zero that the compensation stage 36 introduces into the frequency response of the circuit 32 may track the output pole exactly so as to fully cancel the output pole, or may track the output pole inexactly, but closely enough such that the output pole does not cause the circuit to be unstable for at least any level of the load 30 that falls within an anticipated range load levels.

Still referring to FIG. 3, in more general terms, because a pole and a zero are roots of the denominator and numerator, respectively, of a characteristic equation that represents the frequency response of the circuit 32, it can be said that the compensation stage 36 is configured to introduce into the circuit's frequency response a first numerator or denominator root that tracks, and partially or fully cancels, a second denominator or numerator root so as to stabilize the circuit over a range of at least one variable parameter (e.g., a load) on which the second root depends. That is, the compensation stage 36 may introduce into the frequency response of the circuit 32 a zero that tracks, and that partially or fully cancels, a pole that depends on a varying parameter, or may introduce into the frequency response a pole that tracks, and that partially or fully cancels, a zero that depends on a varying parameter. At least for purposes of this disclosure, a numerator root (i.e., a zero) may be referred to as being an “opposite” (or another form or a synonym of “opposite”) root to a denominator root (i.e., a pole), and a denominator root (i.e., a pole) may be referred to as being an “opposite” (or another form or a synonym of “opposite”) root to a numerator root (i.e., a zero). That is, for example, “a first root and an opposite second root” may refer to a first root that is a pole and a second root that is a zero, or to a first root that is a zero and a second root that is a pole. And, for example, “a first root and a second root” may refer to a first root that is a zero and a second root that is a zero, to a first root that is a zero and a second root that is a pole, to a first root that is a pole and a second root that is a zero, and to a first root that is a pole and a second root that is a pole.

Consequently, the compensation stage 36 may be added to any feedback-coupled stage, such as the feedback-coupled stage 34, to form a feedback-coupled circuit in which a root of the circuit's frequency response is tracked, and partially or fully cancelled, by an opposite root of the circuit's frequency response so as to stabilize the circuit or to impart another characteristic to the circuit.

Still referring to FIG. 3, other embodiments of the feedback-coupled circuit 32 are contemplated. For example, the feedback-coupled stage 34 may include stages in addition to, or in place of, one or both of the input and output stages 38 and 40. Furthermore, the compensation stage 36 may be coupled to the feedback-coupled stage 34 in a manner other than the manner described.

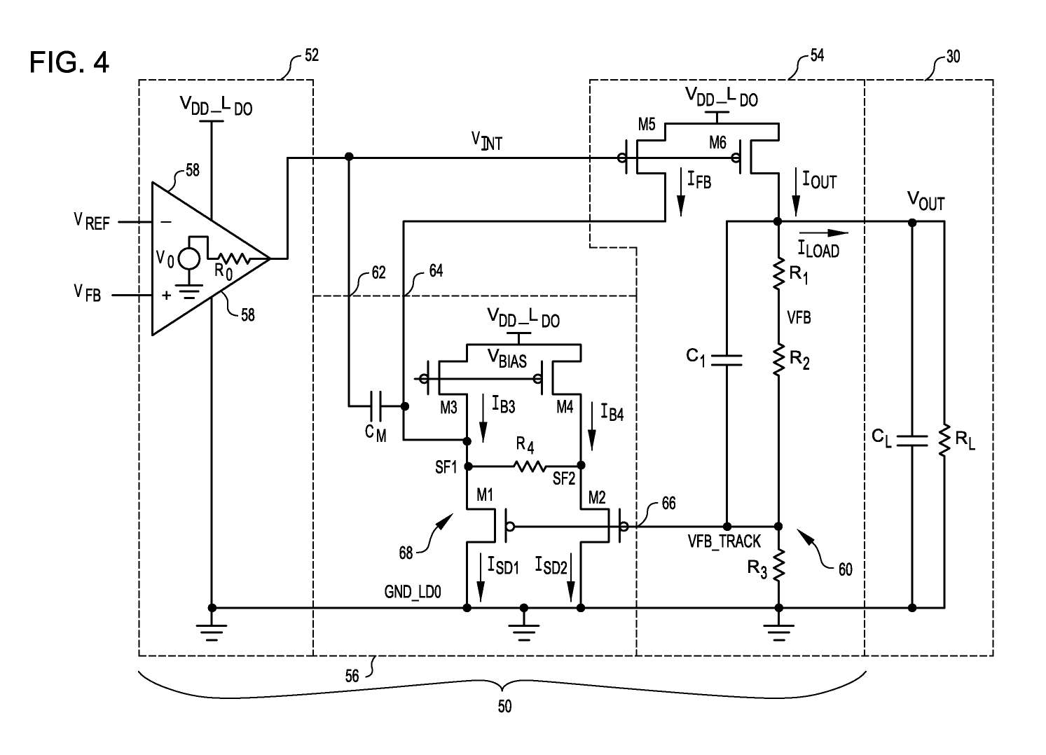

FIG. 4 is a schematic diagram of an embodiment of the load 30 and of the feedback-coupled circuit 32 of FIG. 3; in the described embodiment, the feedback-coupled circuit is a LDO voltage regulator 50 that includes no large output capacitor but that is stable over a range of anticipated levels of the load. The regulator 50 may be formed from discrete components, integrated by itself on an integrated-circuit die, or integrated with other LDO voltage regulators or other circuits on an integrated-circuit die.

In addition to the load 30, which is modeled as a parallel combination of a load resistance R_{L} and a load capacitance C_{L}, the LDO voltage regulator 50 includes an input stage 52, an output stage 54, and a compensation stage 56.

The input stage 52 includes a high-gain differential amplifier 58, such as an operational amplifier, that includes an output resistance Rₒ, that is configured to receive a reference voltage V_{REF} and a feedback voltage V_{FB}, and that is configured to generate an intermediate voltage V_{INT}.

The output stage 54 includes a drive transistor M₆ that is configured to generate a current I_{OUT} in response to the voltage V_{INT}, a mirror transistor M₅ that is configured to generate a feedback current I_{FB}, a compensation capacitor C₁, and a voltage divider 60 that includes series-coupled resistors R₁, R₂, and R₃, which are configured to generate the feedback voltage V_{FB} and another feedback voltage V_{FB}_{_{—}}_{TRACK}.

The compensation stage 56 includes a first node 62 configured to receive the voltage V_{INT}, a second node 64 configured to receive the feedback current I_{FB}, a third node 66 configured to receive the feedback voltage V_{FB}_{_{—}}_{TRACK}, a compensation capacitor C_{M} coupled between the first and second nodes, and a network 68 that is configured to provide a variable resistance that tracks the load resistance R_{L}. As further described below, the capacitor C_{M} and the variable resistance form a zero that tracks, and at least partially cancels, an output pole of the LDO voltage regulator 50. Furthermore, as described below, the capacitor C_{M} is also a factor in the dominant pole of the LDO voltage regulator 50.

The network 68 of the compensation stage 56 includes PMOS bias transistors M₃ and M₄, variable-transconductance PMOS transistors M₁ and M₂, which have their sources respectively coupled to the drains of the transistors M₃ and M₄ and their gates coupled to the third node 66, and a resistor R₄ coupled between the sources of the transistors M₃ and M₄.

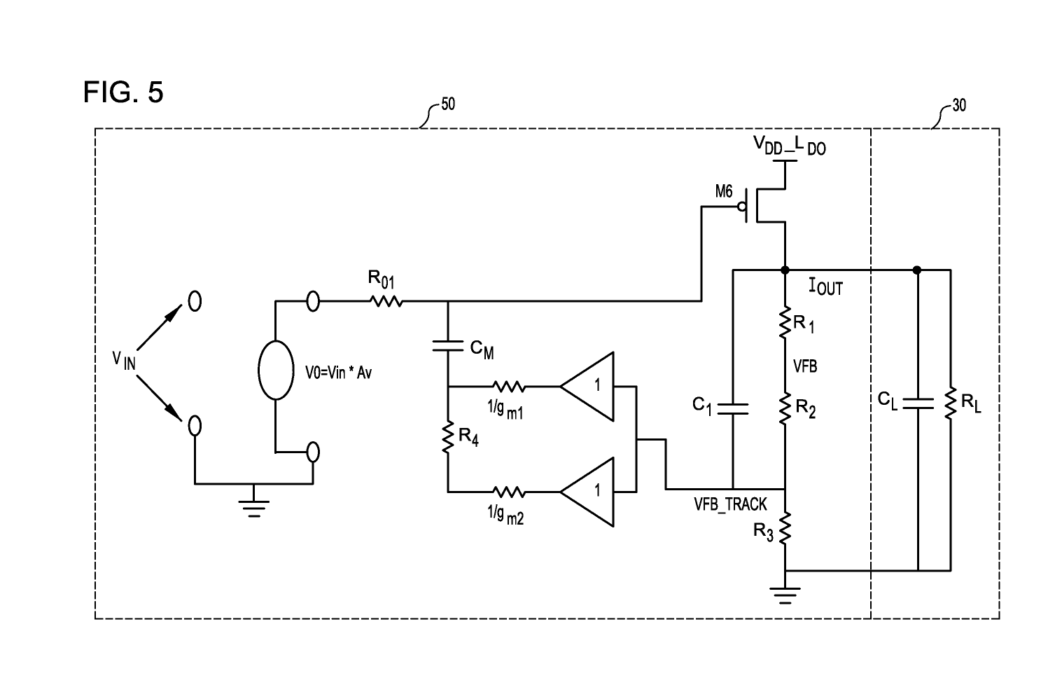

FIG. 5 is a diagram of a simplified circuit model of the load 30 and of the LDO voltage regulator 50 of FIG. 4.

The steady-state and output-root-tracking operations of the LDO voltage regulator 50 are now described in conjunction with FIGS. 4 and 5, where the root that is tracked is an output pole of the LDO regulator, and the opposite root that tracks the output pole is a zero of the LDO regulator.

During steady-state operation, the amplifier 58 generates the voltage V_{INT}, which causes the transistor M₆ to source the current I_{OUT}.

A first portion of the current I_{OUT} is the current I_{LOAD}, which powers the load 30, and a second portion of the current I_{OUT} flows through the voltage divider 60, which generates the feedback voltage V_{FB} according to the following equation:

$${V}_{FB} = {V}_{OUT} \cdot \frac{{R}_{2} + {R}_{3}}{{R}_{1} + {R}_{2} + {R}_{3}} \qquad ( 1 )$$

The amplifier 58 receives V_{FB} at its non-inverting input node, and generates V_{INT} such that V_{FB} equals (within the error tolerance of the amplifier) V_{REF}, which the amplifier receives at its inverting input node and which is a stable reference voltage such as generated by a band gap voltage generator (not shown in FIGS. 4 and 5).

But as described above in conjunction with FIG. 3, as the load resistance R_{L} changes (e.g., due to the load 30 “waking up” or “falling asleep”), an output pole P_{OUT} of the frequency response of the LDO voltage regulator 50 may change, and thus may cause the LDO regulator to become unstable such that, for example, V_{OUT} exhibits ringing in response to transient changes in R_{L}, or, in an extreme case, exhibits oscillation.

To prevent the LDO voltage regulator 50 from becoming unstable, the compensation stage 56 causes the regulator's frequency response to include a zero Z_{TRACK} that tracks, and partially or fully cancels, the output pole P_{OUT}.

The output pole P_{OUT} increases as the load resistance R_{L} decreases and, therefore, as the load current I_{LOAD} increases, and P_{OUT} decreases as R_{L} increases and, therefore, as I_{LOAD} decreases; therefore, the output pole P_{OUT} is proportional to I_{LOAD} and is inversely proportional to R_{L}.

The network 68 of the compensation circuit 56 receives, via the node 64, the feedback current I_{FB}, which is given by the following equation:

I_{FB}=K₁·I_{OUT} (2)

K₁ of equation (2) is a constant that is, in an embodiment, less than one, and that is given by the following equation:

$${K}_{1} = \frac{\frac{{W}_{5}}{{L}_{5}}}{\frac{{W}_{6}}{{L}_{6}}} \qquad ( 3 )$$

where

$$\frac{{W}_{5}}{{L}_{5}}$$

is the width-to-length ratio of the transistor M₅, and

$$\frac{{W}_{6}}{{L}_{6}}$$

is the width-to-length ratio of the transistor M₆. Because I_{FB} is proportional to I_{OUT} per equation (2), and because I_{OUT} is proportional to I_{LOAD} and is inversely proportional to R_{L}, then I_{FB} is also proportional to I_{LOAD} and inversely proportional to R_{L}.

In response to a bias voltage V_{BIAS}, the bias transistor M₃ of the network 68 generates a bias current I_{B3} that flows through, and biases, the transistor M₁; likewise, in response to V_{BIAS}, the bias transistor M₄ generates a bias current I_{B4} that flows through, and biases, the transistor M₂. In an embodiment, the width-to-length ratio of M₄ is less than the width-to-length ratio of M₃ such that I_{B3}>I_{B4}.

And, as further described below, the transconductance gₘ₁ of the transistor M₁ is proportional to the source-to-drain current I_{SD1} that flows through the transistor M₁; likewise, the transconductance gₘ₂ of the transistor M₂ is proportional to the source-to-drain current I_{SD2} that flows through the transistor M₂. In an embodiment, the width-to-length ratio of the transistor M₁ is greater than the width-to-length ratio of the transistor M₂ such that I_{SD1}>I_{SD2}.

Because a first portion of the feedback current I_{FB} flows through the transistor M₁ such that this first portion of I_{FB} is a component of the current I_{SD1}, and because gₘ₁ is proportional to I_{SD1}, the transconductance gₘ₁ of M₁ is proportional to I_{FB}, and is, therefore, proportional to I_{LOAD} and inversely proportional to R_{L}.

Furthermore, because 1/gₘ₁ has units of ohms (Ω), the transistor M₁ effectively functions as a variable resistance Rₘ₁ that is proportional to the effective load resistance R_{L}. That is, as R_{L} increases, Rₘ₁ increases, and as R_{L} decreases, Rₘ₁ decreases.

Similarly, because a second portion of the feedback current I_{FB} flows through the resistor R₄ and the transistor M₂ such that this second portion of I_{FB} is a component of the current I_{SD2}, and because gₘ₂ is proportional to I_{SD2}, the transconductance gₘ₂ of the transistor M₂ is proportional to I_{FB}, and is, therefore, proportional to I_{LOAD} and inversely proportional to R_{L}.

Furthermore, because 1/gₘ₂ has units of Ω, the transistor M₂ also effectively functions as a variable resistance Rₘ₂ that is proportional to R_{L}.

Moreover, because the width-to-length ratio of the transistor M₂ is less than the width-to-length ratio of the transistor M₁, the first portion of I_{FB} that flows through the transistor M₁ is greater than the second portion of I_{FB} that flows through the resistor R₄ and the transistor M₂; therefore, for I_{FB}>0, gₘ₁ of M₁ is greater than gₘ₂ of M₂, and, therefore, Rₘ₁ of M₁ is less than Rₘ₂ of M₂.

Consequently, the network 68 can be modeled as a variable resistance that is coupled between the node 64 and ground such that this variable resistance and the capacitor C_{M} form the zero Z_{TRACK} that tracks, and partially or fully cancels, the output pole P_{OUT} of the LDO regulator's frequency response. As described above, the frequency of the output pole P_{OUT} increases as the load current I_{LOAD} increases and the effective load resistance R_{L} decreases, and P_{OUT} decreases as I_{LOAD} decreases and R_{L} increases. Also as described above, the effective resistance Rₘ₁ of the transistor M₁ and the effective resistance Rₘ₂ of the transistor M₂ also decrease as I_{LOAD} increases and R_{L} decreases. Consequently, the frequency of the zero Z_{TRACK} formed by the capacitor C_{M} and the network 68 also increases as the frequency of the output pole P_{OUT} increases, and decreases as P_{OUT} decreases, such that Z_{TRACK} tracks P_{OUT}. By selecting appropriate values for the width-to-length ratios

$$\frac{{W}_{1}}{{L}_{1}} , \frac{{W}_{2}}{{L}_{2}} , \frac{{W}_{3}}{{L}_{3}} , \frac{{W}_{4}}{{L}_{4}} , \frac{{W}_{5}}{{L}_{5}} , and \frac{{W}_{6}}{{L}_{6}} ,$$

and the resistors R₁, R₂, R₃, and R₄, a designer of the LDO voltage regulator 50 can design the zero Z_{TRACK} to fully cancel the output pole P_{OUT}, or to partially cancel P_{OUT} to a desired degree.

Furthermore, the network 68 may be designed such that at lower values of I_{LOAD} (and, therefore, at higher values of R_{L}), the effective resistances Rₘ₁ and Rₘ₂ of the transistors M₁ and M₂ are relatively high such that R₄ is the dominating resistance factor in the tracking zero Z_{TRACK}. If the LDO voltage regulator 50 is integrated on a die and resistors R₁, R₂, R₃, and R₄ are polysilicon resistors, then this design strategy allows R₄ to track R₁, R₂, and R₃ over process, temperature, and voltage variations that may affect the values of these resistors when I_{LOAD} is relatively low.

And the network 68 may also be designed such that at higher values of I_{LOAD} (and, therefore, at lower values of R_{L}), the effective resistance Rₘ₁ of the transistor M₁ is the dominant factor in the tracking zero Z_{TRACK} such that Z_{TRACK} increases as the output pole P_{OUT} increases, and decreases as P_{OUT} decreases, as described above.

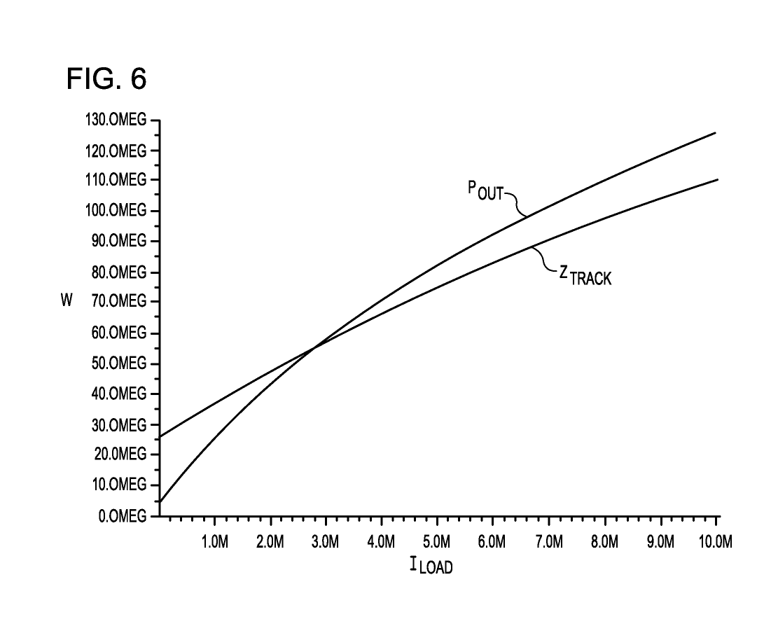

FIG. 6 is a plot of the frequencies of output pole P_{OUT} and of the tracking zero Z_{TRACK} of the LDO voltage regulator 50 of FIGS. 4 and 5, according to an embodiment. The plot shows that the zero Z_{TRACK} tracks the output pole P_{OUT} over a relatively wide range of load current, from about I_{LOAD}=0 milliamperes (mA) to at least about I_{LOAD}=10 mA.

Referring again to FIGS. 4 and 5, the compensation stage 56 may also cause the frequency response of the LDO voltage regulator 50 to have a dominant pole P_{DOMINANT} having a frequency that is lower than the frequency of P_{OUT} and that is relatively constant over a relatively wide range of I_{LOAD}; P_{DOMINANT} having a relatively constant frequency over the anticipated range of I_{LOAD} allows the frequency response of the LDO regulator also to be relatively constant over this same range of I_{LOAD}. In more detail, the capacitor C_{M} is the predominant capacitance in the pole P_{DOMINANT}, and forms P_{DOMINANT} in conjunction with a combination of the following resistances: the output resistance Rₒ of the amplifier 58, the resistors R₁, R₂, and R₃, the inverse of the transconductance gₘ₆ of the transistor M₆, the drain-to-source resistance rds₆ (not shown in FIGS. 4 and 5) of the transistor M₆, and the load resistance R_{L}; the capacitor C_{M} is effectively coupled to the resistors R₁, R₂, and R₃, the transistor M₆, and the load resistance R_{L} through the source-gate junction of the transistor M₁ because M₁ is configured as a source follower.

A reason that P_{DOMINANT} is relatively constant over a relatively wide range of I_{LOAD} is as follows. At relatively low and moderate levels of I_{LOAD}, gₘ₆, Rₒ, and C_{M} increase as I_{LOAD} increases. The increase in gₘ₆ is due to the increase in I_{OUT} as described above, the increase in Rₒ is because the PMOS output pull-up transistor (not shown in FIGS. 4 and 5) of the amplifier 58 starts operating in its saturation region, and the increase in C_{M}, which is a poly-N-well capacitor in an embodiment, is due to C_{M} operating deeper within its accumulation region. But the load resistance R_{L} decreases with increasing I_{LOAD} at about the same combined rate as gₘ₆, Rₒ, and C_{M} increase so that the net change in the frequency of the dominant pole P_{DOMINANT} is approximately zero. As I_{LOAD} continues to increase from a relatively moderate level to a relatively high level, however, the dominant pole P_{DOMINANT} begins to increase relatively slightly, because as the PMOS output pull-up transistor of the amplifier 58 enters into its deep saturation region, the value of Rₒ levels off such that the rate at which R_{L} decreases outpaces the combined rate at which gₘ₆ and C_{M} increase.

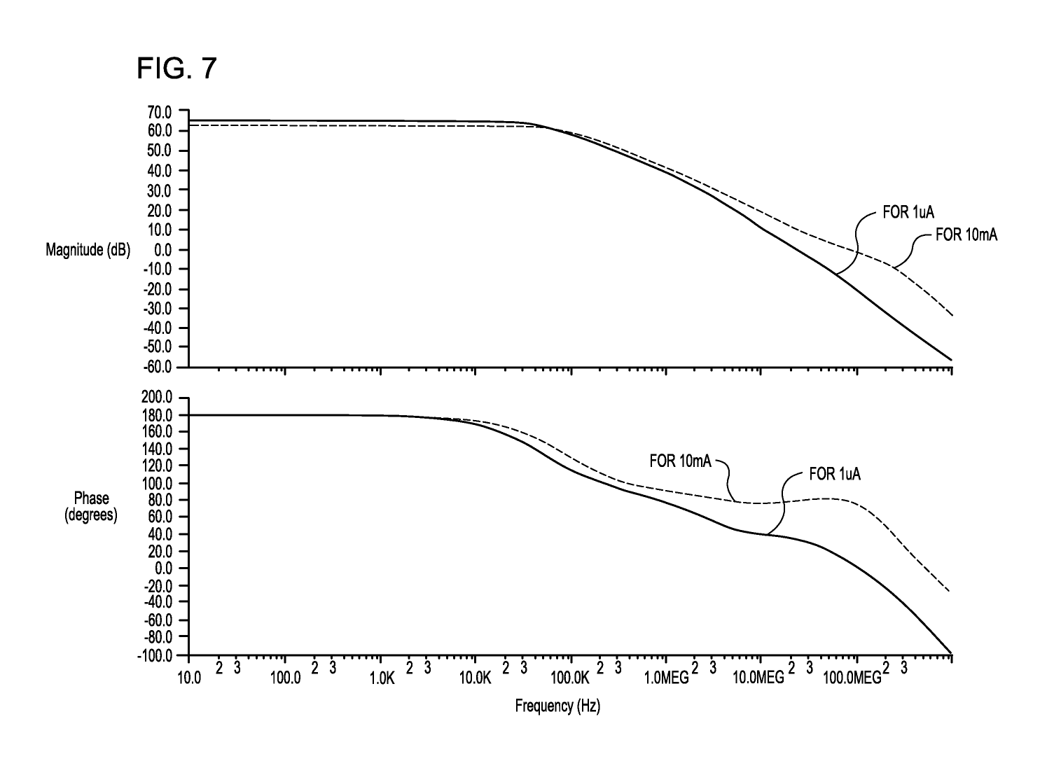

FIG. 7 is a plot of the open-loop frequency response (magnitude and phase) of the LDO voltage regulator 50 of FIGS. 4 and 5 for I_{LOAD}=1.0 μA and I_{LOAD}=10.0 mA, according to an embodiment. At frequencies above about 100 KHz, the magnitude of the open-loop frequency response is slightly greater at I_{LOAD}=10.0 mA than at I_{LOAD}=1.0 μA because, as described above in conjunction with FIGS. 4 and 5, the frequency of the dominant pole P_{DOMINANT} increases at higher values of I_{LOAD}.

Referring again to FIGS. 4 and 5, the LDO voltage regulator 50 may also have a power-supply-rejection ratio (PSRR) and a load-transient step response that are suitable for many applications, and that are as good, or better, than the PSSRs and load-transient step responses of conventional LDO voltage regulators.

Still referring to FIGS. 4 and 5, now provided is a more rigorous mathematical explanation of the frequency response of the LDO voltage regulator 50, and of components of the frequency response such as the dominant pole P_{DOMINANT}, the output pole P_{OUT}, and the zero Z_{TRACK} that tracks, and that partially or fully cancels the effects of, P_{OUT}.

The open-loop transfer function (in the Laplace Transform, i.e., “s”, domain) of the LDO voltage regulator 50 is given by the following equation:

$$\frac{VOUT ( S )}{VIN ( S )} = \frac{{A}_{V} {g}_{m 6} {R}_{L} [ \frac{{SC}_{M}}{{g}_{m 1} \frac{1}{{R}_{4} + 1 / {g}_{m 2}}} + 1 ]}{\begin{matrix}{S}^{2} [ \begin{matrix}{R}_{3}^{′} {R}_{0} {R}_{EQ} {g}_{m 6} {C}_{M} {C}_{1} + {R}_{EQ} {R}_{0} ( {C}_{L} + {C}_{1} ) {C}_{M} + \\ \frac{{R}_{EQ} ( 1 + {g}_{m 2} {R}_{4} ) ( {C}_{L} + {C}_{1} ) {C}_{M}}{{G}_{1}}\end{matrix} ] + \\ S [ \begin{matrix}\frac{( 1 + {R}_{4} {g}_{m 2} ) {C}_{M}}{{G}_{1}} + {R}_{EQ} ( {C}_{L} + {C}_{1} ) + {R}_{0} {C}_{M} + \\ \frac{{R}_{3}}{{R}_{1} + {R}_{2} + {R}_{3}} {g}_{m 6} {R}_{EQ} {R}_{0} {C}_{M}\end{matrix} ] + 1\end{matrix}} \qquad ( 4 )$$

where each variable (e.g., C_{M}, C₁, Rₒ, R₁-R₄, gₘ₁, gₘ₂, gₘ₆, and rds₆) represents the value of the corresponding component previously described above, and R_{EQ}, R′₃, and G₁ are given by the following equations:

R_{EQ}=(R₁+R₂+R₃)∥R_{L}∥rds₆ (5)

R₃′=R₃∥(R₁+R₂) (6)

G₁=gₘ₁(1+gₘ₂R₄)+gₘ₂ (7)

Furthermore, gₘ₁, gₘ₂, and gₘ₆ are given by the following equations:

$$\begin{matrix}{g}_{m 1} = - \sqrt{\frac{2 {μ}_{p} {C}_{ox} {I}_{SD 1} {W}_{1}}{{L}_{1}}} & ( 8 ) \\ {g}_{m 2} = - \sqrt{\frac{2 {μ}_{p} {C}_{ox} {I}_{SD 2} {W}_{2}}{{L}_{2}}} & ( 9 ) \\ {g}_{m 6} = - \sqrt{\frac{2 {μ}_{p} {C}_{ox} {I}_{OUT} {W}_{6}}{{L}_{6}}} & ( 10 )\end{matrix}$$

where the “−” sign is due to the transistors M₁, M₂, and M₆ being PMOS transistors, μₚ represents the respective hole mobilities in the channels of the PMOS transistors M₁, M₂, and M₆, and Cₒₓ represents the respective unit-area capacitances of the gate oxides of these transistors.

And from equation (4), one can derive the following equations for the dominant pole P_{DOMINANT}, the output pole P_{OUT}, and the tracking zero Z_{TRACK} of the LDO voltage regulator 50:

$$\begin{matrix}{P}_{DOMINANT} \approx \frac{1}{{β}_{1} ( {g}_{m 6} {R}_{EQ} {C}_{M} ) {R}_{o}} & ( 11 ) \\ {P}_{OUT} \approx - \frac{{β}_{1}}{( {C}_{L} + {C}_{1} ) ( \frac{1}{{g}_{m 6}} \vert \vert {β}_{1} {R}_{EQ} )} & ( 12 ) \\ {Z}_{TRACK} \approx - \frac{( {g}_{m 1} + \frac{1}{{R}_{4} + 1 / {g}_{m 2}} )}{{C}_{M}} & ( 13 )\end{matrix}$$

where β₁ is given by the following equation:

$${β}_{1} = \frac{{R}_{3}}{{R}_{1} + {R}_{2} + {R}_{3}} \qquad ( 14 )$$

At higher levels of the load current I_{LOAD}, 1/gₘ₆<<β₁·R_{EQ}; therefore, assuming that C_{L}>>C₁ (this is a valid assumption in many applications, including an embodiment of the LDO voltage regulator 50), equation (12) reduces to:

$${P}_{OUT} \approx - \frac{{g}_{m 6}}{{C}_{L}} = \frac{1}{{C}_{L}} \sqrt{{I}_{OUT} * 2 μ {C}_{ox} [ \frac{{W}_{6}}{{L}_{6}} ]} \qquad ( 15 )$$

Similarly at higher levels of the load current I_{LOAD},

$${g}_{m 1} >> \frac{1}{{R}_{4} + 1 / {g}_{m 2}}$$

such that equation (13) reduces to:

$${Z}_{TRACK} \approx - \frac{{g}_{m 1}}{{C}_{M}} = \frac{1}{{C}_{M}} \sqrt{{I}_{SD 1} * 2 μ {C}_{ox} [ \frac{{W}_{1}}{{L}_{1}} ]} = \frac{1}{{C}_{M}} \sqrt{{K}_{1} {I}_{OUT} * 2 μ {C}_{ox} {K}_{2} [ \frac{{W}_{6}}{{L}_{6}} ]} \qquad ( 16 )$$

where

$${K}_{1} \cdot {I}_{OUT} = {I}_{SD 1} , \\ {K}_{2} [ \frac{{W}_{6}}{{L}_{6}} ] = [ \frac{{W}_{1}}{{L}_{1}} ] , \\ {K}_{1} < 1 , \\ and$$

$${K}_{2} < 1$$

Assuming that C_{M} and C_{L} are related by the following equation:

C_{M}=αC_{L} (17)

where α<1 (this is a valid assumption in many applications, including an embodiment of the LDO voltage regulator 50), Z_{TRACK} and P_{OUT} are related by the following equation:

$${Z}_{TRACK} \approx {P}_{OUT} [ \frac{1}{α} \sqrt{{K}_{1} {K}_{2}} ] \qquad ( 18 )$$

Consequently, by selecting appropriate values for α, K₁, and K₂, a circuit designer can determine to what degree Z_{TRACK} cancels P_{OUT}. For example, if the designer sets

$$\frac{1}{α} \sqrt{{K}_{1} {K}_{2}} = 1 ,$$

then Z_{TRACK} fully (or at least almost fully, taking into account the approximations made in the above equations, component error tolerances, etc.) cancels P_{OUT}. But in some applications, the designer may impart a better stability margin to the frequency response of the LDO voltage regulator 50 by setting

$$\frac{1}{α} \sqrt{{K}_{1} {K}_{2}} \neq$$

1.

Furthermore, V_{FB}_{_{—}}_{TRACK} and V_{OUT} are related by the following equation:

$$\frac{VFB\_TRACK ( S )}{VOUT ( S )} = \frac{{R}_{3} [ S ( {R}_{1} + {R}_{2} ) {C}_{1} + 1 ]}{( {R}_{1} + {R}_{2} + {R}_{3} ) [ {SC}_{1} ( {R}_{3} \vert \vert ( {R}_{1} + {R}_{2} ) ) + 1 ]} \qquad ( 19 )$$

And V_{FB} and V_{OUT} are related by the following equation:

$$\frac{VFB ( S )}{VOUT ( S )} = \frac{( {R}_{2} + {R}_{3} )}{( {R}_{1} + {R}_{2} + {R}_{3} )} \frac{\frac{{SC}_{1}}{( 1 + {K}_{3} )} [ \begin{matrix}( {R}_{3} \vert \vert ( {R}_{1} + {R}_{2} ) + \\ ( {R}_{1} + {R}_{2} ) {K}_{3}\end{matrix} ] + 1}{[ {SC}_{1} ( {R}_{3} \vert \vert ( {R}_{1} + {R}_{2} ) ) + 1 ]} \qquad ( 20 )$$

where

$${K}_{3} = \frac{{R}_{1} {R}_{3}}{( {R}_{1} + {R}_{2} + {R}_{3} ) {R}_{2}} .$$

From equation (20), one can see that the capacitor C₁ generates a pole-zero pair, where the zero has a frequency that is lower than the frequency of the pole. If this pole-zero pair is located just outside of the open-loop unity-gain frequency of the LDO voltage regulator 50, then, at higher and full load currents I_{LOAD}, the LDO regulator may have a better margin of stability than if this pole-zero pair is located further away from the unity-gain frequency, or if the capacitor C₁ is omitted altogether from the LDO regulator.

Still referring to FIGS. 4 and 5, examples of values for at least some of the components of an embodiment of the LDO voltage regulator 50 are as follows for a range of I_{LOAD} from about 0-10 mA (gₘ₁, gₘ₂, gₘ₆, K₁, and K₂ can be calculated from the below values and from the above equations):

$${R}_{1} = 2.0 K Ω$$

$${R}_{2} = 10.0 K Ω$$

$${R}_{3} = 8.0 K Ω$$

$${R}_{4} = 1.0 K Ω$$

$${C}_{M} = 8.0 pF$$

$${C}_{1} = 2.7 pF$$

$${C}_{L} = 0.0 - 100.0 pF \\ [ \frac{{W}_{1}}{{L}_{1}} ] = 16 \cdot \frac{5.00 micrometers ( μm )}{0.15 μm} \\ [ \frac{{W}_{2}}{{L}_{2}} ] = 5 \cdot \frac{5.00 μm}{0.15 μm} \\ [ \frac{{W}_{3}}{{L}_{3}} ] = 5 \cdot \frac{10.00 μm}{1.00 μm} \\ [ \frac{{W}_{4}}{{L}_{4}} ] = 3 \cdot \frac{10.00 μm}{1.00 μm} \\ [ \frac{{W}_{5}}{{L}_{5}} ] = 26 \cdot \frac{1.35 μm}{0.15 μm} \\ [ \frac{{W}_{6}}{{L}_{6}} ] = 45 \cdot \frac{60.00 μm}{0.15 μm}$$

Furthermore, alternate embodiments of the LDO voltage regulator 50 are contemplated. For example, the transistor M₂ may be omitted from the compensation circuit 56, and the resistor R₄ may be coupled directly to the node 66 or to ground; but the transistor M₂, when present, serves as a buffer that effectively causes R₄ to have little or no influence on the frequency of the output pole P_{OUT}. Furthermore, a dual of the LDO voltage regulator 50, where the PMOS transistors are replaced with NMOS transistors, may be designed according to the above-described techniques to generate a negative voltage level for V_{OUT}. Moreover, the resistor R₂ may be omitted from the voltage divider 60 such that V_{FB}=V_{FB}_{_{—}}_{TRACK}.

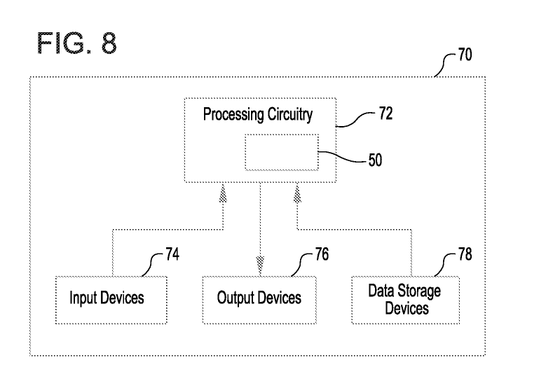

FIG. 8 is a functional block diagram of an electronic system 70, which includes processing circuitry 72 containing one or more of the LDO voltage regulator 50 of FIGS. 4 and 5; for example, the processing circuitry may include the SOC 20 of FIG. 2 where the LDO voltage regulators 26 are each replaced by a respective LDO voltage regulator 50. The processing circuitry 72 includes circuitry for performing various functions, such as executing specific software to perform specific calculations, or controlling the system 70 to provide desired functionality. In addition, the electronic system 70 includes one or more input devices 74, such as a keyboard, mouse, touch screen, audible or voice-recognition component, and so on, coupled to the processing circuitry 72 to allow an operator to interface with the electronic system. Typically, the electronic system 70 also includes one or more output devices 76 coupled to the processing circuitry 72, where the output devices can include a printer, video display, audio output components, and so on. One or more data-storage devices 78 are also typically coupled to the processing circuitry 72 to store data or retrieve data from storage media (not shown). Examples of typical data storage devices 78 include magnetic disks, FLASH memory, other types of solid state memory, tape drives, optical disks like compact disks and digital versatile disks (DVDs), and so on.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated. Moreover, the components described above may be disposed on a single or multiple IC dies to form one or more ICs, these one or more ICs may be coupled to one or more other ICs. In addition, any described component or operation may be implemented/performed in hardware, software, firmware, or a combination of any two or more of hardware, software, and firmware. Furthermore, one or more components of a described apparatus or system may have been omitted from the description for clarity or another reason. Moreover, one or more components of a described apparatus or system that have been included in the description may be omitted from the apparatus or system.

What is claimed is:

1. An electronic circuit, comprising:
a feedback-coupled stage configured to drive a load; and
a compensation stage coupled to the feedback-coupled stage such that a combination of the compensation and feedback-coupled stages has a frequency response including a first root and an opposite second root that depend on the load.

2. The electronic circuit of claim 1 wherein the feedback-coupled stage includes an amplifier.

3. The electronic circuit of claim 1 wherein the feedback-coupled stage includes a voltage regulator.

4. The electronic circuit of claim 1 wherein the first root includes a pole.

5. The electronic circuit of claim 1 wherein the second root includes a zero.

6. The electronic circuit of claim 1 wherein the second root is approximately equal to a product of the first root and a constant.

7. The electronic circuit of claim 1 wherein the compensation stage includes a compensation transistor that is configured to exhibit a transconductance that depends on the load.

8. The electronic circuit of claim 1 wherein the compensation stage is configured to generate a compensation resistance that depends on the load.

9. The electronic circuit of claim 1 wherein the feedback-coupled stage includes:
an input stage configured to receive an input signal and a feedback signal and to generate an intermediate signal; and
an output stage configured to receive the intermediate signal, to generate the feedback signal, and to drive the load

10. The electronic circuit of claim 1 wherein the feedback-coupled stage includes:
an amplifier stage configured to receive an input signal and a feedback signal and to generate an intermediate signal; and
an output stage configured to receive the intermediate signal, to generate the feedback signal, and to drive the load.

11. The electronic circuit of claim 1 wherein the frequency response includes a third root that is lower than the first and second roots.

12. The electronic circuit of claim 1 wherein:
the first root includes a first pole;
the second root includes a zero; and
the frequency response includes a third root that includes a dominant second pole.

13. A system, comprising:
a load; and
a first integrated circuit, including
a feedback-coupled stage configured to drive the load, and
a compensation stage coupled to the feedback-coupled stage such that a combination of the compensation and feedback-coupled stage has a frequency response including a first root and an opposite second root that depend on the load.

14. The system of claim 13 wherein the load includes a second integrated circuit.

15. The system of claim 13 wherein the load includes a computing circuit.

16. The system of claim 13 wherein the load and the integrated circuit are disposed on a same die.

17. The system of claim 13 wherein the load and the integrated circuit are disposed on respective dies.

18. The system of claim 13 wherein the first integrated circuit includes a low-drop-out voltage regulator.

19. A method, comprising:
generating a load current according to a frequency response; and
changing a first root of the frequency response in response to a change in an opposite second root of the frequency response caused by a change in the load current.

20. The method of claim 19 wherein:
the first root includes a zero; and
the second root includes a pole.

21. The method of claim 19 wherein changing the first root includes causing the first root to approximately equal a product of the second root and a constant.

22. The method of claim 19 wherein changing the first root includes changing a compensating resistance in response to the change in the load current.

23. The method of claim 19 wherein changing the first root includes changing a current through a transistor in response to the change in the load current.

24. A compensator, comprising:
a first node configured to receive an intermediate signal from an input stage of a feedback-coupled stage;
a second node configured to receive a first feedback signal from an output stage of the feedback-coupled stage, the feedback signal related to a load current from the output stage;
a capacitor coupled between the first and second nodes; and
a resistance coupled to the second node and related to the feedback signal.

25. The compensator of claim 24 wherein the resistance includes a transistor having a drive node coupled to the second node.

26. The compensator of claim 24, further comprising:
wherein the resistance includes a transistor; and
a resistor coupled to the second node.

27. The compensator of claim 24, further comprising:
a third node configured to receive a second feedback signal from the output node;
wherein the resistance includes a first transistor having a drive node coupled to the second node and having a control node coupled to the third node; and
a second transistor having a drive node coupled to the second node and having a control node coupled to the third node.

28. The compensator of claim 24 wherein the resistance includes a transistor configured to have a transconductance that is related to the first feedback signal.
